(19) United States
(12) Patent Application Publication
(10) Pub. No.: US 2009/0078691 A1
(43) Pub. Date: Mar. 26, 2009

(54) ROOM TEMPERATURE RAISING APPARATUS

(75) Inventor: Ming-Hong Liao, TAIPEI HSIEN (TW)

Correspondence Address: PAI PATENT & TRADEMARK LAW FIRM, 1001 FOURTH AVENUE, SUITE 3200, SEATTLE, WA, 98154, US

(73) Assignee: EIKO (PACIFIC) LTD., PORT LOUIS (MU)

(21) Appl. No.: 11/859,786

(22) Filed: Sep. 23, 2007

(51) Int. Cl. H05B 1/00

(52) U.S. Cl. 219/220

(57) ABSTRACT

A room temperature raising apparatus includes a housing defining a receiving space divided into an air intake chamber and a convection chamber communicable with each other via a through hole; a heating unit mounted on a bottom of the convection chamber to heat cold air into hot air; an airflow guiding device located over the convection chamber and including a plurality of spaced manifolds communicating the convection chamber with an air outlet; and a forced convection unit mounted in the air intake chamber for forcing external cold air into the air intake chamber via an air inlet and then into the convection chamber via the through hole. The hot air produced in the convection chamber flows upward due to a convection effect and is driven by the forced convection unit to flow through the manifolds and be discharged via the air outlet.

### FIELD OF THE INVENTION

The present invention relates to a heating apparatus, and more particularly to a room temperature raising apparatus.

### BACKGROUND OF THE INVENTION

Conventional room temperature raising apparatus may be generally divided into two types. The first type uses a high resistance material, such as a quartz tube or a ceramic tube, to convert electric energy into heat energy and thereby heat ambient air. This type of heating apparatus does not include any device to force the convective air, and the produced hot air tends to stagnate in a small area without flowing to different corners in the room. This type of heating apparatus also vaporizes moisture while it heats the air, resulted in low humidity and dryness in the room.

The second type is similar to the first type but further includes a fan to blow the produced hot air toward different directions. However, the second type of heating apparatus provides a relatively short hot air flow path. That is, the heat producing area is in the vicinity of the fan, and the produced hot air is blown outward before it has evenly mixed with cold air. As a result, the hot air delivered from the heating apparatus has uneven temperature. Moreover, the second type of heating apparatus would still result in low humidity and dryness in the room.

### SUMMARY OF THE INVENTION

It is therefore a primary object of the present invention to provide a room temperature raising apparatus that is able to send out hot air having uniform temperature.

Another object of the present invention is to provide a room temperature raising apparatus that is able to produce hot air without vaporizing moisture in the air.

To achieve the above and other objects, the room temperature raising apparatus according to the present invention includes a housing assembly consisting of an inner and an outer case, a heating unit, an airflow guiding device, and a forced convection unit. The outer case defines a receiving space having an air inlet and an air outlet. The inner case is located in the outer case to divide the receiving space into an air intake chamber and a convection chamber communicable with each other via a through hole on the inner case. The heating unit is mounted on a bottom of the convection chamber to heat cold air into hot air in the convection chamber. The airflow guiding device is mounted to a top of the convection chamber and includes a plurality of spaced airflow-guiding manifolds to communicate with the convection chamber and the air outlet. The forced convection unit is mounted in the air intake chamber adjacent to the through hole for forcing external cold air into the air intake chamber via the air inlet and into the convection chamber via the through hole. The forced convection unit also drives the hot air produced in the convection chamber and flowing upward due to a convection effect to flow from the convection chamber through the manifolds and be discharged via the air outlet.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a room temperature raising apparatus according to a preferred embodiment of the present invention;

FIG. 2 is an assembled perspective view of the room temperature raising apparatus of FIG. 1; and

FIG. 3 is a cutaway perspective view of the room temperature raising apparatus of FIG. 1 showing how the cold air is heated by the apparatus into hot air.

### DETAILED DESCRIPTION OF THE PREFERRED EMBODIMENTS

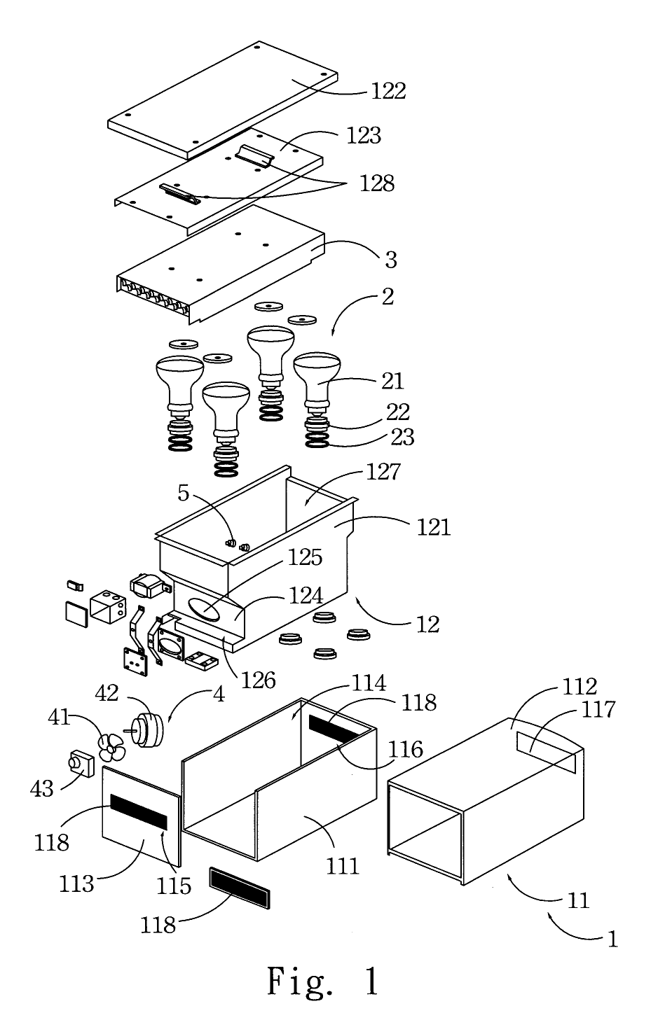

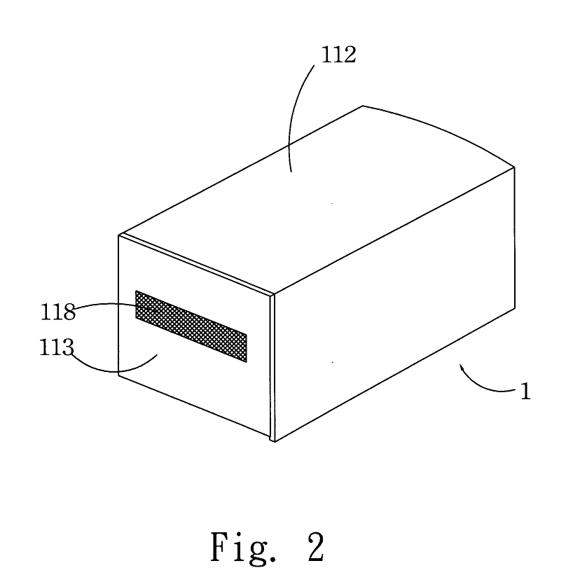

Please refer to FIGS. 1, 2, and 3 at the same time, in which a room temperature raising apparatus according to a preferred embodiment of the present invention is shown. The room temperature raising apparatus includes a housing assembly 1, a heating unit 2, an airflow guiding device 3, and a forced convection unit 4.

The housing assembly 1 includes an outer case 11 and an inner case 12. The outer case 11 consists of a bottom frame 111 having an open front end and an open top, an outer frame 112 having an open front end and adapted for assembling to an outer side of the bottom frame 111, and a front cover 113 adapted to close the open front ends of the bottom frame 111 and the outer frame 112, so as to define a receiving space 114 in the outer case 11. An air inlet 115 is formed on the front cover 113; and two air outlets 116 and 117 are correspondingly formed on rear walls of the bottom frame 111 and the outer frame 112, respectively. In the illustrated embodiment, the air inlet 115 and the air outlets 116, 117 are communicable with the receiving space 114, and each have a screen 118 mounted thereto to prevent a user from carelessly extending fingers into the receiving space 114 via the air inlet 115 and the air outlets 116, 117, and to stop dust and insects from invading the receiving space 114.

The inner case 12 is received in the receiving space 114, and consists of an open-topped box 121, a top plate 122 screwed to the open top of the box 121 to close the same, and an intermediate plate 123 located between the box 121 and the top plate 122. The box 121 is externally formed at a lower front portion with a rearward recess 124, within which a through hole 125 is provided. When the box 121 having the lower front recess 124 is positioned in the outer case 11, the receiving space 114 defined in the outer case 11 is divided by the box 121 into an air intake chamber 126 located in the recess 124 and communicating with the air inlet 115, and a convection chamber 127 located behind the air intake chamber 126 and communicating with the air outlets 116, 117. The intermediate plate 123 has two upward extended spacers 128 arranged thereon to laterally space from each other by a predetermined distance, so that a buffering space exists between the top plate 122 and the intermediate plate 123 to prevent high temperature heat from being transferred to an outer side of the housing assembly 1 via the top plate 122 to undesirably scald a user.

In the illustrated embodiment, the heating unit 2 includes four heat-producing bulbs 21 and other related elements, including bulb seats 22, to which the bulbs 21 are fixedly held, a power supply unit (not shown) electrically connected to the bulbs 21 for supply power thereto, washers 23, and fuses (not shown). The heating unit 2 is mounted on a bottom of the convection chamber 127 in the box 121, so that the bulbs 21 heat cold air in the convection chamber 127 into hot air. In the illustrated embodiment, four bulbs 21 are provided. However, it is understood the number of the bulbs 21 is not specifically limited but may be changed according to actual need in design.

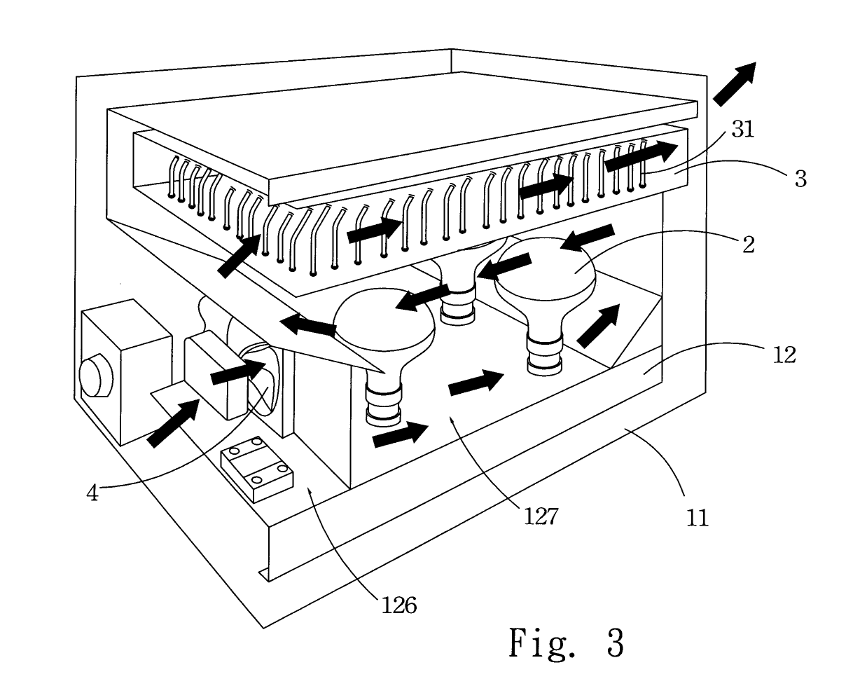

The airflow guiding device 3 is mounted below the intermediate plate 123 to locate above the convection chamber 127. The airflow guiding device 32 includes a plurality of spaced airflow-guiding manifolds 31 communicating with the convection chamber 126 and the air outlets 116, 117 (see FIG. 3), so that hot air may flow from the convection chamber 127 through the airflow-guiding manifolds 31 to an environment outside the room temperature raising apparatus. The airflow-guiding manifolds 31 provide the following two advantages: (1) extending the staying duration of the hot air in the convection chamber 127 to enable good heat concentrating effect; and (2) enabling the produced hot air to flow through an extended flow path, so that the hot air discharged from the apparatus has uniform temperature.

In the illustrated preferred embodiment, the forced convection device 4 includes a fan 41, a motor 42 for driving the fan 41 to rotate, a power supply unit (not shown) electrically connected to the motor 42 for supplying power to the motor 42, and a control switch 43 electrically connected to the motor 42 for controlling the on/off of the motor 42. The forced convection device 4 is mounted in the air intake chamber 126 adjacent to the through hole 125 for forcing external cold air into the air intake chamber 126 via the air inlet 115 and then into the convection chamber 127 via the through hole 125 to be heated. The heated air flows upward in the convection chamber 127 due to a convection effect, and is further driven by the forced convection unit to flow through the airflow-guiding manifolds 31 and finally be discharged via the air outlets 116, 117.

When it is desired to raise room temperature, a user may turn on the forced convection device 4 via the control switch 43, so that the motor 42 is driven to rotate the fan 41. At this point, cold air outside the housing assembly 1 is induced by the forced convection device 4 into the convection chamber 127 via the air inlet 115 and the air intake chamber 126. The cold air in the convection chamber 127 is heated by the bulbs 21 into hot air. Due to the convection effect and a driving force from the fan 41, the hot air in the convection chamber 127 is forced to flow upward into and through the airflow-guiding manifolds 31 to flow out of the air outlets 116, 117 to raise the room temperature.

With the fan 41, the convection chamber 127, and the airflow-guiding manifolds 31 provided in the apparatus of the present invention, an extended air flow path in the apparatus may be obtained to enable fully mixed hot air with uniform temperature, and the discharged hot air may be forced toward different corners in the room. Therefore, the room temperature raising apparatus of the present invention has good applicability. Meanwhile, while the bulbs 21 heat air, they do not cause vaporization of moisture in the air. Therefore, the room temperature raising apparatus of the present invention produces hot air with suitable humidity to create a warm and comfortable environment.

What is to be noted is the present invention may further include a temperature controller 5 electrically connected to the heating unit 2 for controlling heat output by the bulbs 21 of the heating unit 2, so that a user may regulate the heating temperature. Alternatively, casters (not shown) may be mounted to a bottom of the outer case 11, so that the whole room temperature raising apparatus may be conveniently moved around in the room.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A room temperature raising apparatus, comprising:
a housing assembly consisting of an outer case and an inner case; the outer case internally defining a receiving space and having an air inlet and an air outlet provided at a front and a rear end, respectively; the inner case being received in the receiving space of the outer case to divide the receiving space into an air intake chamber communicating with the air inlet and a convection chamber located behind the air intake chamber and communicating with the air outlet, and having a through hole provided thereon to communicate the air intake chamber with the convection chamber;
a heating unit being mounted on a bottom of the convection chamber for heating cold air in the convection chamber into hot air;
an airflow guiding device being mounted over the convection chamber and including a plurality of spaced airflow-guiding manifolds communicating with the convection chamber and the air outlet for the hot air produced in the convection chamber to flow through the airflow-guiding manifolds and be discharged via the air outlet; and
a forced convection unit being mounted in the air intake chamber adjacent to the through hole, so that external cold air is induced by the forced convection unit into the air intake chamber via the air inlet and then into the convection chamber via the through hole on the inner case, and the hot air produced in the convection chamber and flowing upward due to a convection effect is forced by the forced convection unit to flow through the airflow-guiding manifolds and be discharged via the air outlet.

2. The room temperature raising apparatus as claimed in claim 1, wherein the outer case consists of a bottom frame having an open front end and an open top, an outer frame having an open front end for assembling to an outer side of the bottom frame, and a front cover for closing the open front ends of the bottom frame and the outer frame; the air inlet being formed on the front cover, and the air outlet being formed on the bottom frame and the outer frame.

3. The room temperature raising apparatus as claimed in claim 2, wherein the outer case further includes a plurality of screens in a number corresponding to a total number of the air inlet and the air outlet for mounting to the air inlet and the air outlet.

4. The room temperature raising apparatus as claimed in claim 1, wherein the inner case includes an box having an open top and a top plate screwed to the open top of the box to close the same; the box of the inner case being externally formed at a lower front portion with a rearward recess, the air intake chamber being defined by the rearward recess, and the through hole provided on the inner case being extended through the recess to communicate the air intake chamber with the convection chamber, which is located behind the recess.

5. The room temperature raising apparatus as claimed in claim 4, wherein the inner case further includes an intermediate plate located between the box and the top plate, and the intermediate plate having two upward extended spacers arranged thereon to laterally space from each other by a predetermined distance.

6. The room temperature raising apparatus as claimed in claim 1, wherein the heating unit includes at least one heat-producing bulb, at least one bulb seat for fixedly holding the bulb thereto, and a power supply unit electrically connected to the bulb for supplying power thereto.

7. The room temperature raising apparatus as claimed in claim 1, wherein the forced convection unit includes a fan, a motor for driving the fan to rotate, a power supply unit electrically connected to the motor for supplying power thereto, and a control switch electrically connected to the motor for controlling the on/off of the motor.

8. The room temperature raising apparatus as claimed in claim 1, further comprising a temperature controller electrically connected to the heating unit for controlling heat output of the heating unit.
